(19) United States
(12) Patent Application Publication
(10) Pub. No.: US 2021/0310612 A1
(43) Pub. Date: Oct. 7, 2021

(54) DEVICE FOR OUTPUTTING A FUTURE STATE OF A LUBRICATION SYSTEM

(71) Applicant: SKF LUBRICATION SYSTEMS GERMANY GMBH, Walldorf (DE)

(72) Inventors: Juergen Kreutzkaemper, Waibstadt-Daisbach (DE); Stefan Gebauer, Neustadt an der Weinstrasse (DE); Armin Guenther, Helmstadt-Bargen (DE); Dieter Hess, Lambsheim (DE); Andreas Stellmach, Heddesheim (DE)

(21) Appl. No.: 17/266,137

(22) PCT Filed: Jul. 18, 2019
(86) PCT No.: PCT/EP2019/069377

§ 371 Date: Feb. 5, 2021

(30) Foreign Application Priority Data
Aug. 20, 2018 (DE) 10 2018 213 996.2

(51) Int. Cl. F16N 29/00; F16N 7/38

(52) U.S. Cl. CPC F16N 29/00; F16N 7/385; F16N 2230/02; F16N 2260/18; F16N 2250/08; F16N 2250/18; F16N 2250/40; F16N 2250/04

(57) ABSTRACT

A device for outputting a future state of a central lubrication system includes at least one sensor for recording a parameter of the central lubrication system, a processing unit for processing the recorded parameter, determining a current state of the central lubrication system based on the processed parameter, and estimating a future state of the central lubrication system over a certain period of time based on the current state and stored data, and an output unit for outputting the future state of the central lubrication system.

### CROSS-REFERENCE

This application is the U.S. National Stage of International Application No. PCT/EP2019/069377 filed on Jul. 18, 2019, which claims priority to German patent application no. 10 2018 213 996.2 filed on Aug. 20, 2018.

### TECHNOLOGICAL FIELD

The present disclosure relates to a device for outputting a future state of a central lubrication system.

### BACKGROUND

Lubrication systems in machinery, for example, agricultural machinery, are required to ensure sufficient lubrication of the various elements of the machinery. A failure of such a lubrication system can lead to a failure of the elements, such as, for example, of bearings, and thus to a failure of the entire machine. In order to prevent this, a monitoring of the lubrication systems is carried out, which can be effected via switches and sensors. Pressures, volume flows, temperatures, fill levels, cycles, etc. of the lubrication system, of the lubricant used, and/or of the elements can thereby be monitored. Usually the transfer of this recorded information is effected from the lubrication system to a superordinate machine or vehicle control without processing the data. However, the sensors and switches here only reproduce signals about the actual state of the lubrication system, with the result that only already-existing states can be reacted to.

### SUMMARY

It is therefore an aspect of the present disclosure to provide a device using which an estimation of a future state of the central lubrication system is possible.

The device includes at least one sensor for recording a parameter of the central lubrication system. The sensor can be, for example, a temperature sensor, a fill-level sensor, and/or a pressure sensor. Furthermore, the sensor can be a flow sensor or a sensor for detecting contaminants, particles, or lubricants. Other sensors are also possible. Furthermore, a combination of such sensors can also be used. The parameter can be, for example, pressures, volume flows, temperatures, fill levels, cycles, etc. of the central lubrication system. The recorded parameter is transferred to a processing unit. This processes the parameter and determines a current state of the central lubrication system based on the processed parameter. By using the current state as well as stored data, the processing unit can subsequently estimate a future state of the central lubrication system over a certain period of time. The future state of the central lubrication system can be output, via an output unit, for example, to the machine that is lubricated by the central lubrication system. A higher-level machine or vehicle control system can use this information in order to control the central lubrication system.

In contrast to previous system, in this way not only is the actual state of the central lubrication system determined, but a forecast is also provided for a future state of the central lubrication system. Thus even before the occurrence of a faulty state in the central lubrication system, reaction can occur and consequently failures of the entire system can be reliably counteracted. The future state of the central lubrication system can be a changed or unchanged state in comparison to the current state.

Central lubrication systems can be used in various machines. Depending on the application case, central lubrication systems can include various lubrication pumps and distributors that are adapted to the corresponding machine. Central lubrication systems usually have a control system that ensures an optimal supplying of each individual lubrication point. Here the bearings used in the machine can be regularly lubricated directly in running operation.

The at least one sensor can include a first sensor and a second sensor, the second sensor for recording a further parameter of the central lubrication system, and/or the sensor can be configured for recording at least two parameters. In this way the processing unit can estimate the future state of the central lubrication system based on a combination of two or more parameters.

In the following, some examples of parameters are mentioned that in combination provide a certain error pattern in the central lubrication system or a forecast about the performance of the central lubrication system. However, it should be noted that these are only examples and they are not to be considered as limiting, but rather a variety of combinations is possible. For example, the number of operating hours until a refilling of the lubricant tank can be determined by a combination of the current fill-level indicator and a lubrication interval per time unit. A combination of pressure, time, and temperature can indicate the wear of the injectors, a leakage in the main line, defective valves, or a defective pump. Information about the hydraulic pressure at the input of the pump and the grease pressure at the output of the pump can reveal a blockage/damage of the pump. The pressure at the hydraulic input, the pressure at the lubricant outlet, the pumping quantity of the lubricant, and the temperature can in combination indicate the efficiency of the pump or also pump damage. The hydraulic pressure at the input, the pressure at the output, and the time duration for a cycle can indicate the wear on the piston seal. Instead of the hydraulic pressure at the input of the hydraulic motor, with electrically driven pumps the motor current can be used as a comparable data source.

The future state can in particular indicate a failure probability of the central lubrication system and/or a maintenance timing of the central lubrication system. The failure probability can be determined, for example, by the detection of signal changes of the parameters recorded by the sensors. The maintenance timing can be, for example, the pre-calculation of the operating hours up to the next refilling in a manner depending on the consumption.

By determining the failure probability and/or of the maintenance time point the failure risk of the machine can be reduced. Repair times can be better planned. If, for example, the lubricant consumption is recorded over time, a pre-ordering of lubricant is possible and the maintenance can be carried out appropriately. Furthermore, consequential damage to the machine can be avoided, since faults are recognized even before they lead to machine failure.

According to a further embodiment the current state of the central lubrication system can indicate a fault of the central lubrication system. Based on the parameters, the processing unit can determine the position of such a fault. In this way, in addition to a forecast about future failures an improvement of the determining of actual, already occurring faults can be achieved.

Since based on a combination of sensor signals (e.g., due to lack of one or more signals) it can be determined where a fault has occurred, repair times can be better planned and reduced since the damage source can already be identified early on. For this purpose the output unit can output the current state of the central lubrication system and the position of the fault. By indicating the fault (the current state of the central lubrication system) and the position, the method and/or the material in the event of a fault can be determined in a simple manner. For example, the required specialist (mechanical- or electrical-field) can be determined and the damaged parts can be ordered in advance. The repair times can thus be reduced.

According to one embodiment the stored data are historical data. These can have been determined and stored based on past faults, failures, and states. In particular, the data can be stored in the form of a lookup table.

In a further embodiment the output unit can transmit the current and/or the future state to a storage device. These states can be stored in the storage device, for example, as historical data and used for a further recognition of states.

The storage device can in particular be an external storage device, for example, a cloud storage. The output unit can communicate with the storage device via a radio connection. The radio connection can be a Bluetooth or a mobile connection. Other types of communication connection are also possible.

The data transmitted to the external storage device can also be used for external state monitoring. This means that in this case no monitoring is required on site, but rather can be remote and carried out centrally.

Furthermore, a method is provided for outputting a future state of a central lubrication system. The method includes the following steps: recording a parameter of the central lubrication system, processing of the recorded parameter, determining a current state of the central lubrication system based on the processed parameter, estimating of a future state of the central lubrication system over a certain time period based on the current state and stored data, and outputting of the future state of the central lubrication system.

Furthermore, a computer program product is provided that includes a program code that is configured to trigger the carrying out of the method as explained above on a computer.

A computer program product, such as, for example, a computer program medium, can be provided or delivered as a storage medium, such as, e.g., storage card, USB stick, CD-ROM, DVD, or also in the form of a downloadable file from a server in a network. This can be effected, for example, in a wireless communication network by the transmission of a corresponding file including the computer program product or the computer program means.

Further advantages and advantageous embodiments are specified in the description, the drawings, and the claims. Here in particular the combinations of features specified in the description and in the drawings are purely exemplary, so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 shows a schematic block diagram of a device for outputting a future state of a central lubrication system.

### DETAILED DESCRIPTION

In the following, identical or functionally equivalent elements are designated by the same reference numbers.

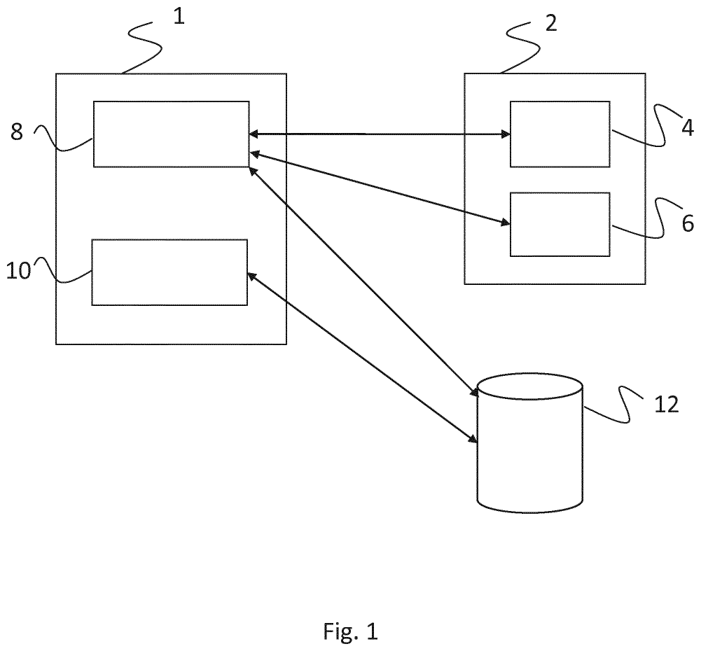

FIG. 1 shows a device 1 for outputting a future state of a central lubrication system 2. The device 1 can be disposed separate from the central lubrication system 2 or can form a part of the central lubrication system 2.

In order to detect a state of the central lubrication system 2, the device 1 includes one or more sensors 4, 6. These sensors 4, 6 serve to record parameters of the central lubrication system 2, such as, for example, temperatures, pressures, volume flows, etc.

These parameters are processed by a processing unit 8. Based on the parameters and stored data a current state of the central lubrication system is thereby determined and a future state of the central lubrication system is estimated. The stored data can be stored in a storage device 12.

In particular, the processing unit 8 determines the current and the future state of the central lubrication system 2 based on a combination of the parameters of the sensors 4, 6. In this way in addition to the current state, i.e., possible already occurring faults, of the central lubrication system 2 a failure probability of the central lubrication system 2 for the future and/or a maintenance timing can also be estimated. In this way repair times can be easily planned. Downtime due to failures of the central lubrication system 2 can be reduced since it can already be estimated in advance when a failure/fault will occur, and therefore countermeasures can already be taken before a failure.

The parameters can be, for example, a current fill-level indicator and a lubrication interval per time unit. Based thereon the processing unit 8 can estimate the number of operating hours until a refilling of the lubricant tank.

In addition to the future state, the processing unit 8 can precisely specify the current state based on the parameters. This means that in the case of a fault, not only the fault itself, but also the position of the fault can be determined. For this purpose a combination of parameters is also used. Various combinations of parameters with their associated error pattern can be stored in the storage device 12.

An output unit 10 can be used to output the current state and the future state. On the one hand the output unit 10 can indicate these states. On the other hand the output unit 10 can transmit these states to the storage device 12. The output unit 10 or the processing unit 8 can communicate with the storage device 12 via a communication connection, in particular a radio connection.

In summary, by the above-described device not only can the current state of a central lubrication system be determined, but an estimation about a future state of the central lubrication system can also be carried out. In this way it is possible to already take corresponding countermeasures or correspondingly plan maintenance and repairs even before a fault or failure of the central lubrication system.

### REFERENCE NUMBER LIST

1 Device
2 Central lubrication system
4, 6 Sensors
8 Processing unit
10 Output unit
12 Storage device

1. A device for outputting a future state of a central lubrication system, including:
at least one sensor for recording a parameter of the central lubrication system,
a processing unit for processing the recorded parameter, determining a current state of the central lubrication system based on the processed parameter, and estimating of a future state of the central lubrication system over a certain period of time based on the current state and stored data, and
an output unit for outputting the future state of the central lubrication system.

2. The device according to claim 1, wherein:
the at least one sensor is configured to record at least two parameters, and
wherein the processing unit is configured to estimate the future state of the central lubrication system based on a combination of the at least two parameters.

3. The device according to claim 1, wherein the future state indicates a failure probability of the central lubrication system and/or a maintenance timing of the central lubrication system.

4. The device according to claim 1, wherein the current state of the central lubrication system indicates a fault of the central lubrication system, and wherein the processing unit is configured to determine a position of the fault.

5. The device according to claim 4, wherein the output unit is configured to output the current state of the central lubrication system and the position of the fault.

6. The device according to claim 1, wherein the sensor is a temperature sensor, a fill-level sensor, a pressure sensor, a flow sensor, a contamination sensor, and/or a lubricant-detection sensor.

7. The device according to claim 1, wherein the stored data are historical data.

8. (canceled)

9. The device according to claim 1, wherein the output unit is configured to transmit the current and/or the future state to a storage device.

10. The device according to claim 9, wherein the storage device is an external storage device and the output unit is configured to communicate with the storage device via a communication connection.

11. The device according to claim 10, wherein the communication connection is a radio connection.

12. The device according to claim 2,
wherein the future state indicates a failure probability of the central lubrication system and/or a maintenance timing of the central lubrication system,
wherein the current state of the central lubrication system indicates a fault of the central lubrication system, and the processing unit is configured to determine a position of the fault,
wherein the output unit is configured to output the future and/or current state of the central lubrication system and the position of the fault to a storage device,
wherein the sensor is a temperature sensor, a fill-level sensor, a pressure sensor, a flow sensor, a contamination sensor, and/or a lubricant-detection sensor, and
wherein the stored data are historical data.
